(19) United States
(12) Patent Application Publication
(10) Pub. No.: US 2025/0125528 A1
(43) Pub. Date: Apr. 17, 2025

(54) ELECTRONIC DEVICE AND ANTENNA STRUCTURE

(71) Applicant: WISTRON NEWEB CORPORATION, HSINCHU (TW)

(72) Inventors: SHIH-CHIANG WEI, HSINCHU (TW); YUNG-CHIEH YU, HSINCHU (TW); HSIEH-CHIH LIN, HSINCHU (TW)

(21) Appl. No.: 18/644,217

(22) Filed: Apr. 24, 2024

(30) Foreign Application Priority Data
Oct. 11, 2023 (TW) 112138650

(51) Int. Cl. H01Q 5/385; H01Q 1/22

(52) U.S. Cl. CPC H01Q 5/385; H01Q 1/2291

(57) ABSTRACT

An electronic device includes a housing, an antenna structure, and a feeding element. The antenna structure includes a grounding element, a feeding radiation element, a switching circuit, and a first parasitic radiation element. The feeding radiation element includes a feeding portion, a first radiating portion, a second radiating portion, a first grounding arm, and a second grounding arm. The feeding portion is connected between the first radiating portion and the second radiating portion. The first grounding arm and the second grounding arm are connected to the first radiating portion. The switching circuit is electrically connected to the first grounding arm and the second grounding arm. The first parasitic radiation element is connected to the grounding element and coupled with the feeding radiation element.

### CROSS-REFERENCE TO RELATED PATENT APPLICATION

This application claims the benefit of priority to Taiwan Patent Application No. 112138650, filed on Oct. 11, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an antenna structure and an electronic device, and more particularly to an antenna structure capable of covering multiple frequency bands and an electronic device having the antenna structure.

### BACKGROUND OF THE DISCLOSURE

Currently, exterior designs of electronic devices, such as laptop computers, are developed toward being thinner and more lightweight, while needing to maintain high levels of performance. Since there is a tendency for an outer appearance of the laptop computer to be designed with a narrow screen frame, an internal space of the laptop computer that is available for placement of an antenna is very limited. Thus, due to the requirement of having a narrow screen frame on the electronic device, an issue of decreasing or insufficient bandwidth is likely to occur in the antenna.

Therefore, how to design an antenna structure capable of simultaneously transmitting and receiving multiple wireless frequency bands and having good antenna efficiency within the limited internal space of the electronic device has become an important issue to be addressed in the related art.

### SUMMARY OF THE DISCLOSURE

In response to the above-referenced technical inadequacy, the present disclosure provides an antenna structure and an electronic device, which can address an issue of the antenna structure not having a sufficient bandwidth due to miniaturization requirements of the electronic device.

In order to solve the above-mentioned problems, one of the technical aspects adopted by the present disclosure is to provide an electronic device, which includes a housing, an antenna structure, and a feeding element. The antenna structure is disposed in the housing. The antenna structure includes a grounding element, a feeding radiation element, a switching circuit, and a first parasitic radiation element. The feeding radiation element includes a feeding portion, a first radiating portion, a second radiating portion, a first grounding arm, and a second grounding arm. The feeding portion is connected between the first radiating portion and the second radiating portion. The first grounding arm and the second grounding arm are connected to the first radiating portion. The switching circuit is electrically connected to the first grounding arm and the second grounding arm. The first parasitic radiation element is connected to the grounding element and coupled with the feeding radiation element. The feeding element being is used to feed a signal. The feeding element includes a grounding end and a feeding end, the grounding end is electrically connected to the grounding element, and the feeding end is electrically connected to the feeding portion. In response to the switching circuit being switched to a first mode, the signal passes through the first grounding arm, and in response to the switching circuit being switched to a second mode, the signal passes through the second grounding arm.

In order to solve the above-mentioned problems, another one of the technical aspects adopted by the present disclosure is to provide an antenna structure, which includes a grounding element, a feeding radiation element, a switching circuit, and a first parasitic radiation element. The feeding radiation element includes a feeding portion, a first radiating portion, a second radiating portion, a first grounding arm, and a second grounding arm. The feeding portion is connected between the first radiating portion and the second radiating portion. The first grounding arm and the second grounding arm are connected to the first radiating portion. The switching circuit is electrically connected to the first grounding arm and the second grounding arm. The first parasitic radiation element is connected to the grounding element and coupled with the feeding radiation element. The feeding portion is used for being fed a signal through the feeding element. In response to the switching circuit being switched to a first mode, the signal passes through the first grounding arm, and in response to the switching circuit being switched to a second mode, the signal passes through the second grounding arm.

Therefore, in the antenna structure and the electronic device provided by the present disclosure, by virtue of “the first grounding arm and the second grounding arm being connected to the first radiating portion,” “a switching circuit being electrically connected to the first grounding arm and the second grounding arm” and “in response to the switching circuit being switched to a first mode, the signal passes through the first grounding arm, and in response to the switching circuit being switched to a second mode, the signal passes through the second grounding arm,” the antenna structure can satisfy requirements of multiple frequency bands despite miniaturization of the electronic device.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of an electronic device according to the present disclosure;

FIG. 2 is a schematic view of an antenna structure according to a first embodiment of the present disclosure;

FIG. 3 is a first schematic perspective view of the antenna structure according to the first embodiment of the present disclosure;

FIG. 4 is a second schematic perspective view of the antenna structure according to the first embodiment of the present disclosure;

FIG. 5 is a schematic view of a switching circuit according to the first embodiment of the present disclosure;

FIG. 6 is a schematic view of an antenna structure according to a second embodiment of the present disclosure;

FIG. 7 is a schematic view of a switching circuit according to the second embodiment of the present disclosure;

FIG. 8 is a schematic view of an antenna structure according to a third embodiment of the present disclosure;

FIG. 9 is a schematic view of a switching circuit according to the third embodiment of the present disclosure;

FIG. 10 is a schematic view of an antenna structure according to a fourth embodiment of the present disclosure; and

FIG. 11 is a schematic view of an antenna structure according to a fifth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

In addition, the term “connect” or “connected” in the context of the present disclosure means that there is a physical connection between two elements, and the two elements are directly or indirectly connected. The term “couple” or “coupled” in the context of the present disclosure means that two elements are separate from each other and have no physical connection therebetween, and an electric field energy generated by one of the two elements excites an electric field energy generated by another one of the two elements.

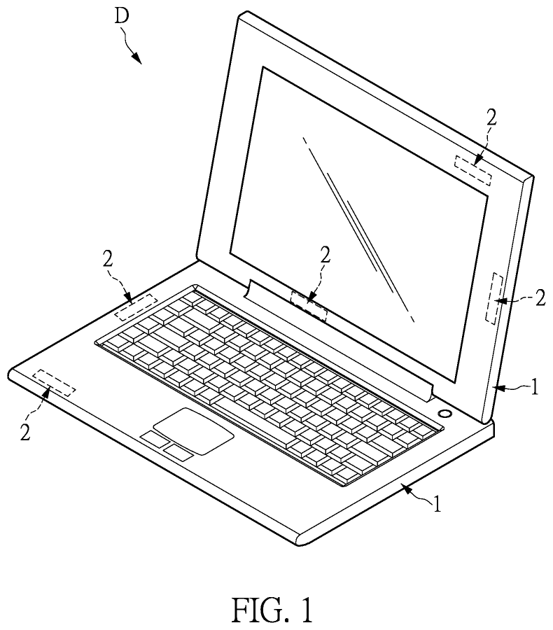

Referring to FIG. 1, FIG. 1 is a schematic view of an electronic device according to the present disclosure. The present disclosure provides an electronic device D, and the electronic device D can be a smart phone, a tablet computer, or a laptop computer. However, the present disclosure is not limited thereto. In the present disclosure, the electronic device D is exemplified as the laptop computer. The electronic device D includes a housing 1 and an antenna structure 2 that is disposed in the housing 1. The electronic device D can generate at least one operating frequency band through the antenna structure 2. For example, the antenna structure 2 is disposed at a position of a screen frame of the electronic device D, but the position and quantity of the antenna structure 2 in the electronic device D are not limited in the present disclosure.

### First Embodiment

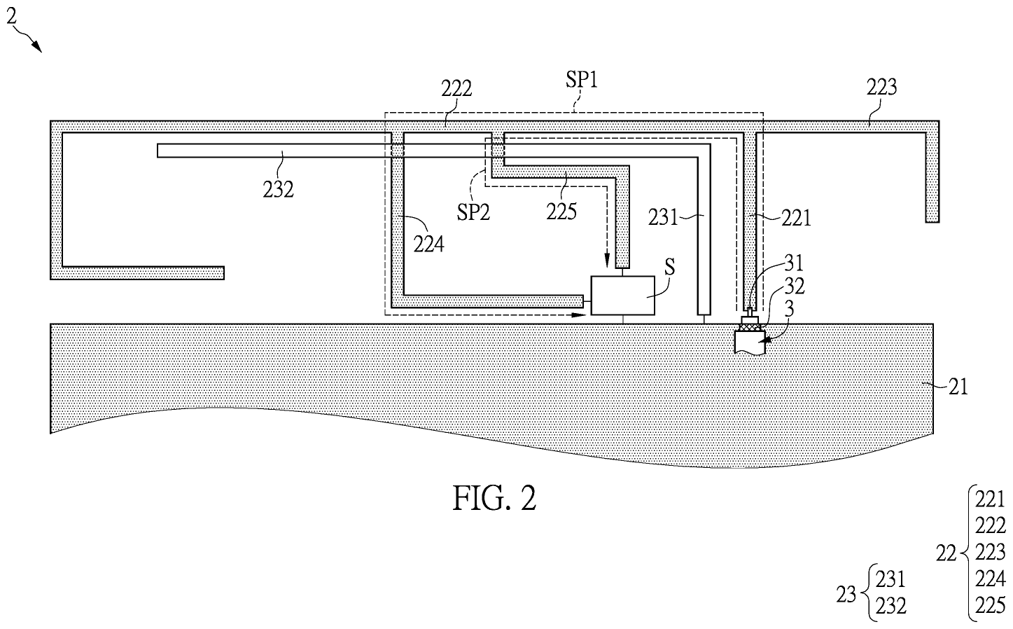

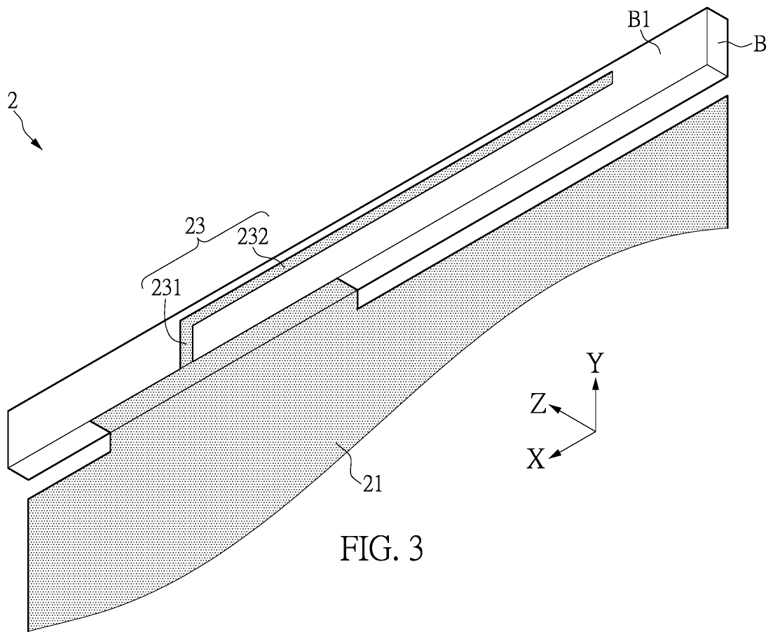

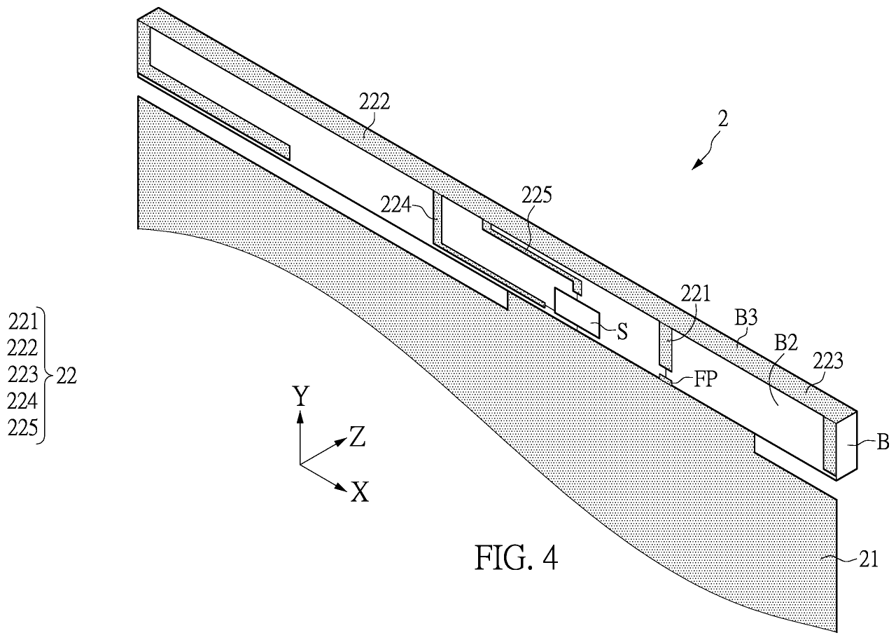

Referring to FIG. 1 and FIG. 2, FIG. 2 is a schematic view of an antenna structure according to a first embodiment of the present disclosure. The first embodiment of the present disclosure provides an antenna structure 2, which includes a grounding element 21, a feeding radiation element 22, a switching circuit S, and a first parasitic radiation element 23. Referring to FIG. 3 and FIG. 4, FIG. 3 and FIG. 4 are different schematic perspective views of the antenna structure according to the first embodiment of the present disclosure. For example, the antenna structure 2 can be disposed on a substrate B, and the feeding radiation element 22 and the first parasitic radiation element 23 can be respectively located on opposite sides of the substrate B. As shown in FIGS. 3 and 4, the first parasitic radiation element 23 is disposed on a first surface B1, and the feeding radiation element 22 is disposed on a second surface B2. The first surface B1 and the second surface B2 are located on opposite sides of the substrate B. As shown in FIGS. 2 and 3, the antenna structure 2 shown in FIG. 2 is presented in a same direction (a negative Z-axis direction) as a direction towards which a user faces the first surface B1 of FIG. 3.

The feeding radiation element 22 includes a feeding portion 221, a first radiating portion 222, a second radiating portion 223, a first grounding arm 224, and a second grounding arm 225. The feeding portion 221 is connected between the first radiating portion 222 and the second radiating portion 223. The first grounding arm 224 and the second grounding arm 225 are connected to the first radiating portion 222. The switching circuit S is electrically connected to the first grounding arm 224 and the second grounding arm 225. The first parasitic radiation element 23 is connected to the grounding element 21, and the first parasitic radiation element 23 is coupled with at least one radiating portion of the feeding radiation element 22.

The electronic device D further includes a feeding element 3 that is used to feed a signal. For example, the feeding element 3 can be a coaxial cable, but the present disclosure is not limited thereto. The feeding element 3 includes a feeding end 31 and a grounding end 32. The grounding end 32 is connected to the grounding element 21, and the feeding end 31 is connected to the feeding portion 221. Therefore, the signal can be fed into the antenna structure 2 through the feeding portion 221 and be excited to generate the at least one operating frequency band.

Furthermore, the first radiating portion 222 and the second radiating portion 223 of the feeding radiation element 22 extend to a third surface B3 of the substrate B. The third surface B3 is connected between the first surface B1 and the second surface B2. However, the way that the antenna structure 2 is presented is not limited in the present disclosure. In addition, it should be noted that only a feed point FP is used to indicate a location of the feeding element 3 in FIGS. 3 and 4, and the feeding element 3 is omitted and not shown in the figures. Through the configuration of the substrate B, the feeding radiation element 22 and the first parasitic radiation element 23 are separated from each other. Although the switching circuit S in FIGS. 3 and 4 is disposed on the second surface B2, the specific position of the switching circuit S is not limited in the present disclosure, as long as the switching circuit S can be electrically connected to the first grounding arm 224, the second grounding arm 225, and grounding element 21.

When the signal is fed into the antenna structure 2 through the feeding portion 221, the first radiating portion 222 and the first parasitic radiation element 23 in the feeding radiation element 2 are coupled with each other and generate operating frequency bands covering 880 MHz to 960 MHz, 1,500 MHz, 2,690 MHz, and 4 GHz to 5 GHz. Moreover, the first radiating portion 222 and the first parasitic radiation element 23 are coupled with each other, and are switched to different modes through the switching circuit S to generate operating frequency bands covering 617 MHz to 960 MHZ, 1,900 MHZ, and 3,300 MHz. In addition, the second radiating portion 223 is used to be excited to generate operating frequency bands covering 1,710 MHz to 2,500 MHz, and 4 GHz.

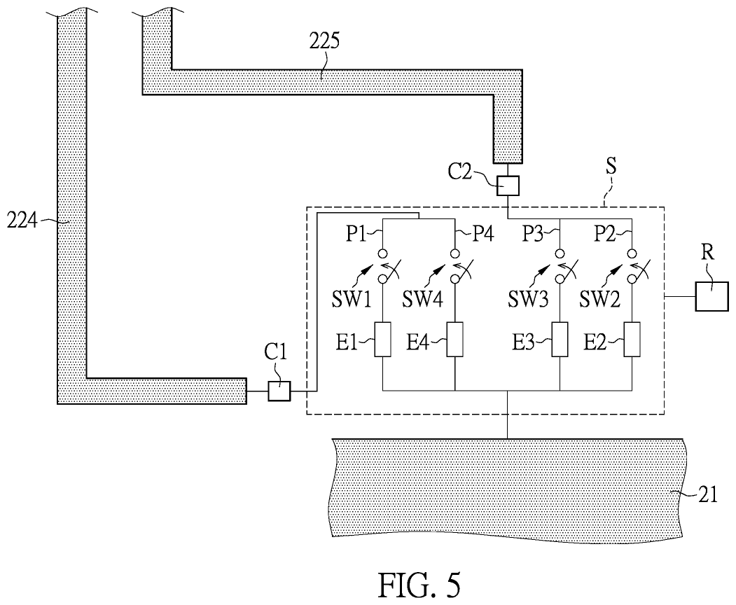

Referring to FIG. 2 and FIG. 5, FIG. 5 is a schematic view of a switching circuit according to the first embodiment of the present disclosure. The switching circuit S includes a first path P1 and a second path P2. The first path P1 includes a first switch SW1, and the second path P2 includes a second switch SW2. One end of the first path P1 is electrically connected to the first grounding arm 224, and another end of the first path P1 is electrically connected to the grounding element 21. One end of the second path P2 is electrically connected to the second grounding arm 225, and another end of the second path P2 is electrically connected to the grounding element 21. An equivalent impedance of the first path P1 is different from an equivalent impedance of the second path P2.

In the antenna structure 2 of the present disclosure, the signal passes through signal coupling paths with different lengths or different equivalent impedances by the switching circuit S being switched among different modes. Moreover, the electronic device D further includes a control circuit R. The control circuit R can control the switches of the switching circuit S, and switch the switching circuit S to one of the modes, so as to adjust the operating frequency band generated by the antenna structure 2. The switching mechanism of the switching circuit S in different modes will be described in detail below. It should be noted that, when describing one of the modes below, only the switch in a conducting state is referred to, and other switches not referred to are to be in a non-conducting state.

In response to the switching circuit S being switched to a first mode, the first switch SW1 is in the conducting state. The signal passes through the feeding portion 221, a part of the first radiating portion 222, and the first grounding arm 224, and is grounded through the first path P1, such that the first radiating portion 222 is coupled with the first parasitic radiation element 23 to generate a first operating frequency band. The path traveled by the signal in the first mode is shown by a dotted line SP1 in FIG. 2.

In response to the switching circuit S being switched to a second mode, the second switch SW2 is in the conducting state. The signal passes through the feeding portion 221, a part of the first radiating portion 222, and the second grounding arm 225, and is grounded through the second path P2, such that the first radiating portion 222 is coupled with the first parasitic radiation element 23 to generate a second operating frequency band. The path traveled by the signal in the second mode is shown by a dotted line SP2 in FIG. 2.

As shown in FIG. 2 and FIG. 5, in the first mode, the signal is grounded from the feeding end 32 through the first grounding arm 224 (i.e., the dotted line SP1). Meanwhile, the first operating frequency band generated by the antenna structure 2 is affected by the second grounding arm 225. Similarly, in the second mode, the signal is grounded from the feeding end 32 through the second grounding arm 225 (i.e., the dotted line SP2). Meanwhile, the second operating frequency band generated by the antenna structure 2 is affected by the first grounding arm 224. Since a length of the first grounding arm 224 is greater than a length of the second grounding arm 225, the second operating frequency band is shifted to a lower frequency range than the first operating frequency band. Therefore, a center frequency of the first operating frequency band will be higher than a center frequency of the second operating frequency band. For example, the first operating frequency band covers a LTE band 5, and the second operating frequency band covers a LTE band 71.

A quantity of the paths in the switching circuit S is not limited in the present disclosure. For example, as shown in FIG. 5, the switching circuit S further includes a third path P3 and a fourth path P4. The third path P3 includes a third switch SW3, and the fourth path P4 includes a fourth switch SW4. An equivalent impedance of the third switch SW3 is different from an equivalent impedance of the fourth path P4. One end of the third path P3 is electrically connected to the second grounding arm 225, and another end of the third path P3 is electrically connected to the grounding element 21. One end of the fourth path P4 is electrically connected to the first grounding arm 224, and another end of the fourth path P4 is electrically connected to the grounding element 21. According to the design of the third path P3 and the fourth path P4, the switching circuit S can be switch to a third mode and a fourth mode.

In response to the switching circuit S being switched to the third mode, the fourth switch SW4 is in the conducting state. The signal passes through the first grounding arm 224 and is grounded through the fourth path P4, such that the first radiating portion 222 is coupled with the first parasitic radiation element 23 to generate a third operating frequency band. For example, the third operating frequency band covers a LTE band 28.

In response to the switching circuit S being switched to the fourth mode, the third switch SW3 and the fourth switch SW4 are in the conducting state. The signal simultaneously passes through the first grounding arm 224 and the second grounding arm 225, and is grounded through the third path P3 and the fourth path P4, such that the first radiating portion 222 is coupled with the first parasitic radiation element 23 to generate a fourth operating frequency band. For example, the fourth operating frequency band covers a LTE band 14.

In the first mode to the fourth mode, at least one of the switches of the switching circuit S is in the conducting state, such that the feeding radiation element 22 is formed to a planar inverted-F antenna (PIFA) structure. However, the present disclosure is not limited thereto. For example, the switching circuit S can be switched to a fifth mode. In response to the switching circuit S being switched to the fifth mode, all of the switches (i.e., SW1˜SW4) are in the non-conducting state, such that the feeding radiation element 22 is formed to a monopole antenna structure. In the fifth mode, the first radiating portion 222 is coupled with the first parasitic radiation element 23 to generate a fifth operating frequency band. For example, the fifth operating frequency band covers a LTE band 8.

In addition, in the present disclosure, the first path P1, the second path P2, the third path P3, and the fourth path P4 are respectively connected to a first passive element E1, a second passive element E2, a third passive element E3, and a fourth passive element E4. The different paths of the switching circuit 4 can achieve different equivalent impedances by connecting to different passive elements. The passive elements (i.e., E1˜E4) can be inductors, capacitors, or resistors, and the present disclosure is not limited thereto. For example, the first passive element E1 and the second passive element E2 are resistors having resistances of 0 ohm, the third passive element E3 is an inductor having an inductance of 3 nH, and the fourth passive element E4 is an inductor having an inductance of 5.1 nH.

Therefore, the operating frequency band, impedance matching, and radiation efficiency generated by the antenna structure 2 can be adjusted through the grounding arms (i.e., the first grounding arm 224 and the second grounding arm 225) and the passive elements (i.e., E1˜E4) in the switching circuit S. Comparing the first mode with the second mode, in the two modes, the first passive element E1 and the second passive element E2 are resistors having resistances of 0 ohm, and the antenna structure 2 generates different operating frequency bands (i.e., the first operating frequency band and the second operating frequency band) through different grounding arms (i.e., the first grounding arm 224 and the second grounding arm 225). In addition, comparing the first mode with the third mode, in the two modes, the signal passes through the same grounding arm (i.e., the first grounding arm 224), and the antenna structure 2 generates different operating frequency bands through different passive elements, that is, the first passive element E1 (i.e., the resistor having the resistance of 0 ohm) and the fourth passive element E4 (i.e., the inductor having the inductance of 5.1 nH).

### Second Embodiment

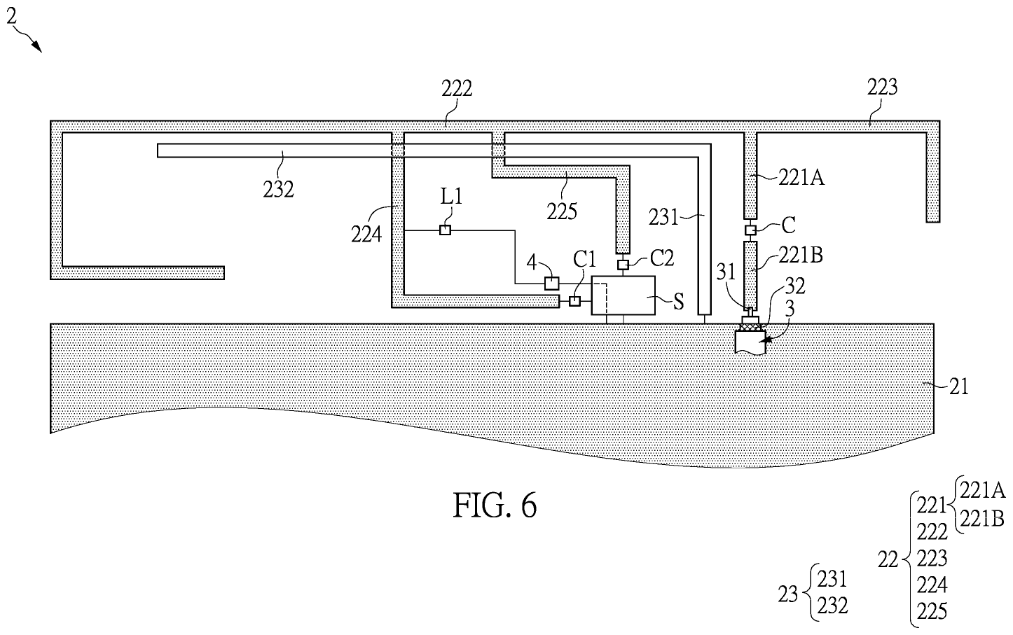

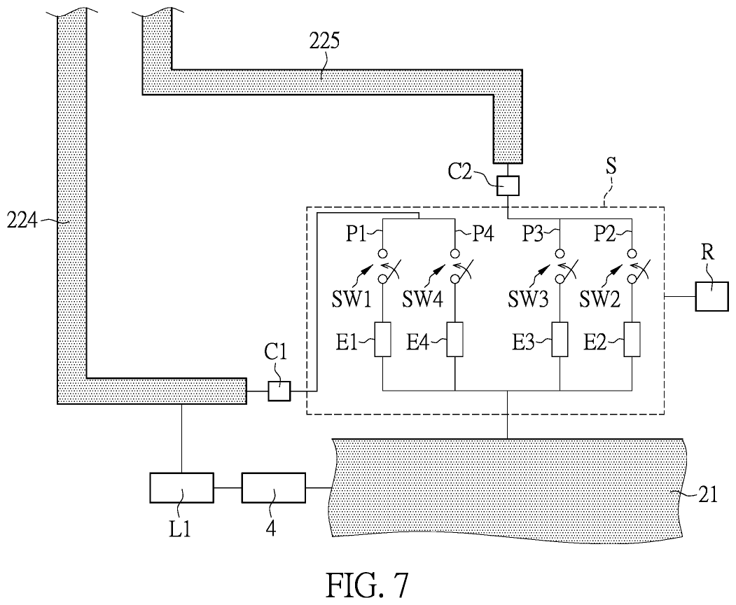

Referring to FIG. 6 and FIG. 7, FIG. 6 is a schematic view of an antenna structure according to a second embodiment of the present disclosure, and FIG. 7 is a schematic view of a switching circuit according to the second embodiment of the present disclosure. The antenna structure 2 of the second embodiment has a structure similar to that of the first embodiment, and the similarities therebetween will not be reiterated herein. The main difference between the second embodiment and the first embodiment is as follows: in the second embodiment, the antenna structure 2 further includes a proximity sensing circuit 4 that is electrically connected to the first grounding arm 224. The antenna structure 2 further includes a first inductor L1 and at least one capacitor. The at least one capacitor is electrically connected between the grounding arm (i.e., the first grounding arm 224 and the second grounding arm 225) and the grounding element 21. Specifically, the at least one capacitor is electrically connected between the grounding arm (i.e., the first grounding arm 224 and the second grounding arm 225) and the switching circuit S, or electrically connected between the switching circuit S and the grounding element 21. A quantity of the at least one capacitor is not limited in the present disclosure. For example, in FIG. 6 and FIG. 7, the antenna structure 2 includes a first capacitor C1 and a second capacitor C2. The first inductor L1 is electrically connected between the proximity sensing circuit 4 and the first grounding arm 224. The first capacitor C1 is electrically connected between the first grounding arm 224 and the switching circuit S. The second capacitor C2 is electrically connected between the second grounding arm 225 and the switching circuit S.

The proximity sensing circuit 4 can be, for example, a capacitance sensing circuit. The feeding radiation element 22 of the antenna structure 2 can be used as a sensing electrode for the proximity sensing circuit 4 to measure the capacitance. The proximity sensing circuit 4 can measure a distance between an object (e.g., the leg or other body parts of a user) and the antenna structure 2. The proximity sensing circuit 4 is further electrically connected to a mainboard (not shown in the figures). A sensing signal detected by the proximity sensing circuit 4 through the sensing electrode is sent back to the mainboard. In this way, the electronic device D can be used to sense whether or not the human body is in close proximity of the antenna structure 2, and the radiation power transmitted by an RF module (not shown in the figures) on the mainboard to the antenna can be adjusted, thereby preventing a specific absorption rate (SAR) at which electromagnetic wave energy is absorbed per unit mass by an organism from being too high.

Moreover, the feeding portion 221 includes a first segment 221A and a second segment 221B. The first segment 221A is connected to the first radiating portion 222, and the second segment 221B is electrically connected to the feeding element 3. The antenna structure 2 further includes a capacitor C that is electrically connected between the first segment 221A and the second segment 221B.

For example, the capacitor C has an capacitance of 39 pF, and the first capacitor C1 and the second capacitor C2 have capacitances of 56 pF, and the first inductor L1 has an inductance of 100 nH. The capacitor C can serve as a DC block to prevent a DC signal generated by the proximity sensing circuit 4 from transmitting into a system end inside the electronic device D through the feeding element 3. The first capacitor C1 and the second capacitor C2 can also serve as the DC blocks to prevent the DC signal generated by the proximity sensing circuit 4 from transmitting to ground through the switching circuit S. The first inductor L1 can serve as an RF choke to prevent the RF signal from transmitting into the proximity sensing circuit 4.

The specific position of the proximity sensing circuit 4 is not limited in the present disclosure. For example, the proximity sensing circuit 4 can be integrated into the switching circuit S. The proximity sensing circuit 4 can also be independently disposed outside the switching circuit S, such as being disposed on the substrate B of the antenna structure 2 or adjacent to the antenna structure 2. Alternatively, the proximity sensing circuit 4 can be independently disposed on the mainboard.

### Third Embodiment

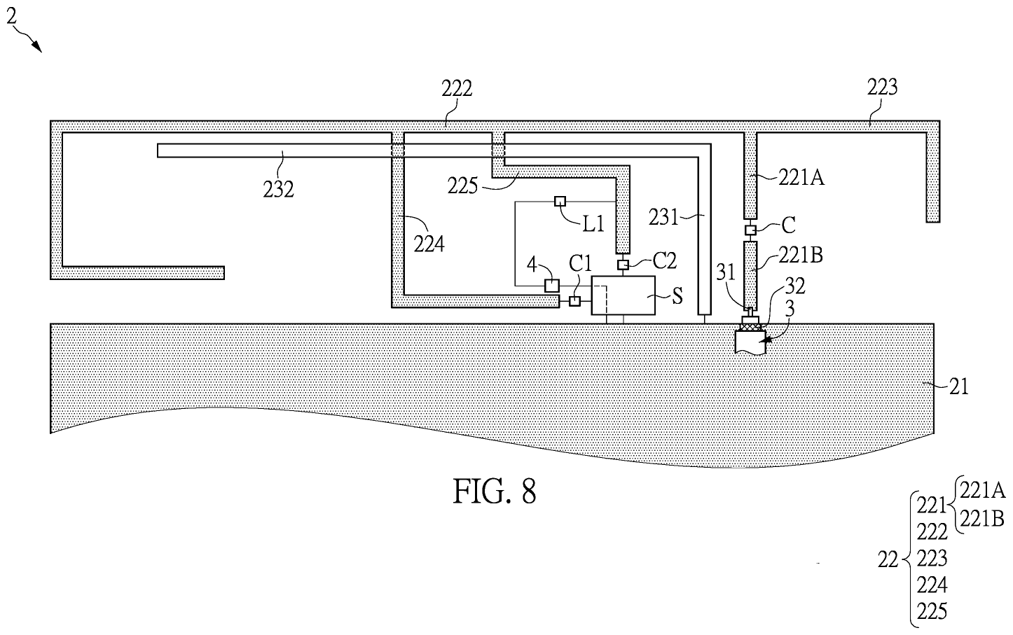

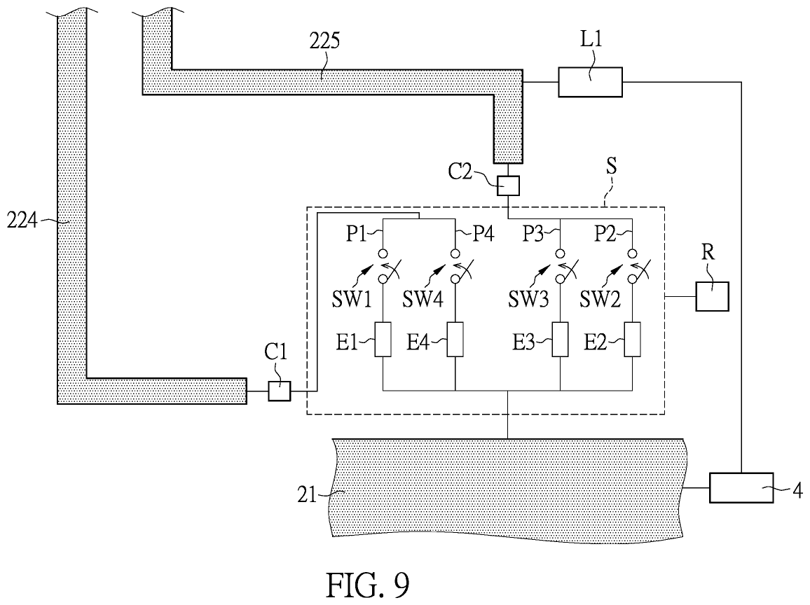

Referring to FIG. 8 and FIG. 9, FIG. 8 is a schematic view of an antenna structure according to a third embodiment of the present disclosure, and FIG. 9 is a schematic view of a switching circuit according to the third embodiment of the present disclosure. The antenna structure 2 of the third embodiment has a structure similar to that of the second embodiment, and the similarities therebetween will not be reiterated herein. The main difference between the third embodiment and the second embodiment is as follows: in the antenna structure 2 of the third embodiment, the proximity sensing circuit 4 is electrically connected to the second grounding arm 225, and the first inductor L1 is electrically connected between the proximity sensing circuit 4 and the second grounding arm 225.

### Fourth Embodiment

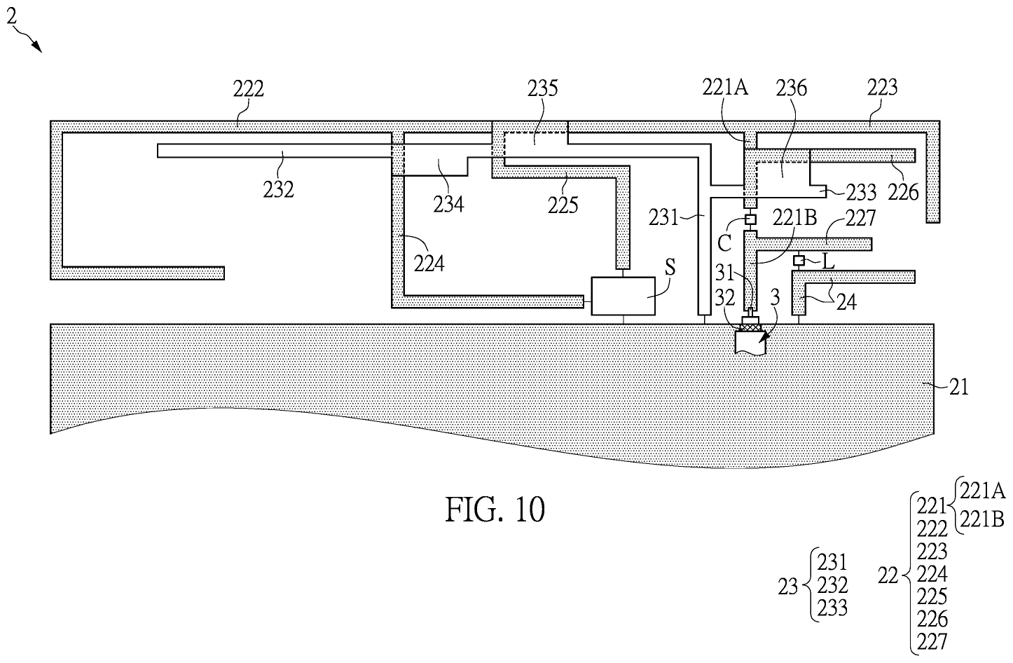

Referring to FIG. 10, FIG. 10 is a schematic view of an antenna structure according to a fourth embodiment of the present disclosure. The antenna structure 2 of the fourth embodiment has a structure similar to that of the third embodiment, and the similarities therebetween will not be reiterated herein. The main difference between the fourth embodiment and the third embodiment is as follows: the feeding radiation element 22 of the antenna structure 2 further includes a second parasitic radiation element 24, a third radiation portion 226, and a fourth radiating portion 227. The second parasitic radiation element 24 and the feeding radiation element 22 can be located on the same surface of the substrate B, and the form of the substrate B is shown in FIGS. 3 and 4. The second parasitic radiation element 24 is connected between the grounding element 21 and the fourth radiating portion 227. The third radiating portion 226 and the fourth radiating portion 227 are connected to the feeding portion 221. The third radiating portion 226 is used to generate an operating frequency band covering 2.4 GHz, and the fourth radiating portion 227 is used to generate an operating frequency band covering 5 GHz. The fourth radiating portion 227 is more adjacent to the grounding element 21 than the third radiating portion 226. The second parasitic radiation element 24 and the third radiating portion 226 are separated from and coupled with each other, to generate an operating frequency band covering 5 GHz to 6 GHz and adjust the matching in the medium frequency range.

The antenna structure 2 further includes an inductor L and a capacitor C. The feeding portion 221 includes a first segment 221A and a second segment 221B. The first segment 221A is connected to the first radiating portion 222, and the second segment 221B is connected to the fourth radiating portion 227. The capacitor C is electrically connected between the first section 221A and the second section 221B. The inductor L is electrically connected between the fourth radiating portion 227 and the second parasitic radiation element 24. The impedance matching of the antenna structure 2 can be adjusted through the configuration of the inductor L and the capacitor C.

The first parasitic radiation element 23 includes a first branch 231, a second branch 232, and a third branch 233. The first branch 231 is connected between the grounding element 21 and the second branch 232, and the third branch 233 is connected to the first branch 231.

The first parasitic radiation element 23 further includes a first matching element 234, a second matching element 235, and a third matching element 236. The first matching element 234 and the second matching element 235 are disposed on the second branch 232, and the third matching element 236 is disposed on the third branch 233. The first matching element 234 and the first grounding arm 224 are coupled with each other, to adjust the matching in a high frequency range of 4 GHz to 5 GHz. The second matching element 235 and the second grounding arm 225 are coupled with each other, to control an amount of the frequency offset in a frequency range of 2,690 MHz and 3,800 MHZ. The third matching element 236 and the feeding portion 221 are coupled with each other, to adjust the matching in the high frequency range of 4 GHz to 5 GHz.

When the antenna structure 2 is disposed on a carrier (e.g., the substrate B shown in FIGS. 3 and 4, but the present disclosure is not limited thereto), the feeding radiation element 22 and the first parasitic radiation element 23 can be located on opposite sides of the carrier. Therefore, the first matching element 234 and the first grounding arm 224 have a first coupling gap therebetween, the second matching element 235 and the second grounding arm 225 have a second coupling gap therebetween, and the third matching element 236 and the feeding portion 221 have a third coupling gap therebetween. Preferably, each of the first coupling gap, the second coupling gap, and the third coupling gap is less than 5 mm.

### Fifth Embodiment

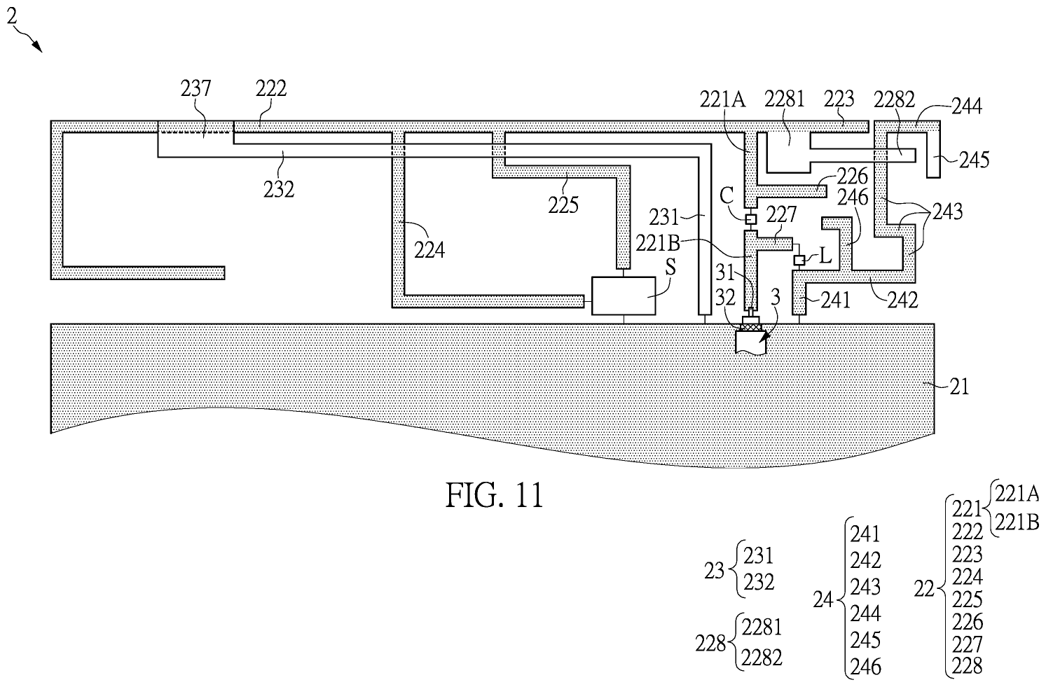

Referring to FIG. 11, FIG. 11 is a schematic view of an antenna structure according to a fifth embodiment of the present disclosure. The antenna structure 2 of the fifth embodiment has a structure similar to that of the fifth embodiment, and the similarities therebetween will not be reiterated herein. The main difference between the fifth embodiment and the fourth embodiment is as follows: in the fifth embodiment, the second parasitic radiation element 24 of the antenna structure 2 includes a first arm 241, a second arm 242, a third arm 243, a fourth arm 244, and a fifth arm 245. The first arm 241, the second arm 242, the third arm 243, the fourth arm 244, and the fifth arm 245 are bent to form an S shape.

The first arm 241 is connected to the grounding element 21. The second arm 242 is connected between the first arm 241 and the third arm 243. The third arm 243 is connected between the second arm 242 and the fourth arm 244. The fourth arm 244 is connected between the third arm 243 and the fifth arm 245. The inductor L is electrically connected between the first arm 241 and the fourth radiating portion 227. In addition, it should be noted that each component of the second parasitic radiation element 24 can be located on different surfaces of the substrate B. The form of the substrate B is as shown in FIGS. 3 and 4. For example, the first arm 241, the second arm 242, the third arm 243 and the fourth arm 244 can be located on the same surface of the substrate B as the feeding radiation element 22, that is, the second surface B2. The fifth arm 245 can extend along a side of the substrate B to another surface of the substrate B, that is, the first surface B1.

The second parasitic radiation element 24 further includes a sixth arm 246. The sixth arm 246 is connected to the second arm 242. The sixth arm 246 and the third radiating portion 226 are coupled with each other to generate an operating frequency band covering a frequency range from 5 GHz to 6 GHz.

In the fifth embodiment, in addition to the different structures of the second parasitic radiation element 24, the structures of the feeding radiation element 22 and the first parasitic radiation element 23 are also different. The feeding radiation element 22 also includes a fifth radiating portion 228, and the fifth radiating portion 228 is connected to the second radiating portion 223. The fifth radiating portion 228 can be coupled with the fifth arm 245 to generate an operating frequency band covering a frequency range of 1,850 MHz to 2,690 MHz, and 1,427 MHz to 1,850 MHz.

In addition, each component of the feeding radiation element 22 can be located on the different surfaces of the substrate B. The form of the substrate B is as shown in FIGS. 3 and 4. For example, the feeding portion 221, the first radiating portion 222, the second radiating portion 223, the first grounding arm 224, the second grounding arm 225, the third radiating portion 226, and the fourth radiating portion 227 are located on the second surface B2 of the substrate B, and the fifth radiating portion 228 is located on the first surface B1 of the substrate B.

Furthermore, the fifth radiating portion 228 includes a first extension section 2281 and a second extension section 2282. The first extension section 2281 is connected between the second radiating portion 223 and the second extension section 2282. As shown in FIG. 11, the second extension section 2282 extends along an extending direction relative to the first extension section 2281. Each of the first extension section 2281 and the second extension section 2282 has a longitudinal width that is perpendicular to the extending direction. The longitudinal width of the first extension section 2281 is greater than the longitudinal width of the second extension section 2282. Thereby, the impedance matching of the antenna structure 2 can be adjusted by increasing the longitudinal width of the first extension section 2281.

Moreover, the first parasitic radiation element 23 includes a first branch 231, a second branch 232 and a matching element 237. The first branch 231 is connected between the grounding element 21 and the second branch 232. The matching element 237 is disposed on the second branch 232. The matching element 237 and the first radiating portion 22 are coupled with each other to adjust the frequency offset and the matching of a low frequency band covering 617 MHz to 960 MHz.

### Beneficial Effects of the Embodiments

In the electronic device D and the antenna structure 2 thereof provided by the present disclosure, by the design of the first grounding arm 224, the second grounding arm 225, and the switching circuit S, the antenna structure 2 can generate a low frequency range covering 617 MHz to 960 MHz.

Moreover, through the design of the antenna structure 2 of the present disclosure, the operating frequency band of the antenna structure 2 can cover a full range of LTE frequencies (from 617 MHz to 5,925 MHZ) that includes the low frequency band (from 617 MHz to 960 MHZ). Furthermore, while the low frequency band is being adjusted by the switching circuit S, variation of medium and high frequency bands is small, and good radiation efficiency can be maintained.

In addition, the signal coupling paths of the antenna structure 2 can be diversified through switching of the switches (i.e., the first switch SW1, the second switch SW2, the third switch SW3, and the fourth switch SW4). The signal can travel along one of the coupling paths, or travel along the multiple coupling paths simultaneously, so as to improve the adjustability of the operating frequency band of the antenna and optimize the antenna matching. Thus, the antenna structure 2 of the present disclosure can be used as a main antenna and can meet more stringent antenna characteristic requirements.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An electronic device, comprising:
a housing;
an antenna structure disposed in the housing, wherein the antenna structure includes:
a grounding element;
a feeding radiation element including a feeding portion, a first radiating portion, a second radiating portion, a first grounding arm, and a second grounding arm, wherein the feeding portion is connected between the first radiating portion and the second radiating portion, and the first grounding arm and the second grounding arm are connected to the first radiating portion;
a switching circuit electrically connected to the first grounding arm and the second grounding arm; and
a first parasitic radiation element connected to the grounding element and coupled with the feeding radiation element; and
a feeding element being used to feed a signal, wherein the feeding element includes a grounding end and a feeding end, the grounding end is electrically connected to the grounding element, and the feeding end is electrically connected to the feeding portion;
wherein, in response to the switching circuit being switched to a first mode, the signal passes through the first grounding arm, and in response to the switching circuit being switched to a second mode, the signal passes through the second grounding arm.

2. The electronic device according to claim 1, wherein a transmission path length of the signal from the feeding end to the grounding element via the first grounding arm is greater than a transmission path length of the signal from the feeding end to the grounding element via the second grounding arm.

3. The electronic device according to claim 1, wherein the switching circuit includes a first path and a second path, the first path has a first switch, the second path has a second switch; wherein, in response to the switching circuit being switched to the first mode, the first switch is in a conducting state, and in response to the switching circuit being switched to the second mode, the second switch is in the conducting state; wherein an equivalent impedance of the first path is different from an equivalent impedance of the second path.

4. The electronic device according to claim 1, wherein the switching circuit includes a plurality of switches, and when the plurality of switches are in the conducting state, the signal passes through the first grounding arm and the second grounding arm.

5. The electronic device according to claim 4, wherein, when the plurality of switches are in a non-conducting state, the signal does not pass through the first grounding arm and the second grounding arm, and an operating frequency band generated by the antenna structure when the plurality of switches are in the conducting state is different from an operating frequency band generated by the antenna structure when the plurality of switches are in the non-conducting state.

6. The electronic device according to claim 1, wherein the feeding radiation element further includes a third radiating portion and a fourth radiating portion, the third radiating portion and the fourth radiating portion are connected to the feeding portion, and the fourth radiating portion is more adjacent to the feeding element than the third radiating portion.

7. The electronic device according to claim 6, wherein the antenna structure further includes a second parasitic radiation element, the second parasitic radiation element is connected between the grounding element and the fourth radiating portion, and the second parasitic radiation element and the third radiating portion are separated from and coupled with each other.

8. The electronic device according to claim 7, wherein the antenna structure further includes an inductor and a capacitor, the feeding portion includes a first segment and a second segment, the first segment is connected to the first radiating portion, the second segment is connected to the fourth radiating portion, the capacitor is electrically connected between the first segment and the second segment, and the inductor is electrically connected between the fourth radiating portion and the second parasitic radiation element.

9. The electronic device according to claim 8, wherein the second parasitic radiation element is bent, the second parasitic radiation element includes a first arm, a second arm, a third arm, a fourth arm, and a fifth arm, the first arm is connected to the grounding element, the second arm is connected between the first arm and the third arm, the third arm is connected between the second arm and the fourth arm, the fourth arm is connected between the third arm and the fifth arm, and the inductor is electrically connected between the first arm and the fourth radiating portion.

10. The electronic device according to claim 9, wherein the second parasitic radiation element further includes a sixth arm that is connected to the second arm, and the sixth arm is coupled with the third radiating portion.

11. The electronic device according to claim 9, wherein the feeding radiation element further includes a fifth radiating portion that is connected to the second radiating portion, and the fifth radiating portion is coupled with the fifth arm.

12. The electronic device according to claim 11, wherein the fifth radiating portion includes a first extension section and a second extension section, and the first extension section is connected between the second radiating portion and the second extension section; wherein the second extension section extends along an extending direction relative to the first extension section, each of the first extension section and the second extension section has a longitudinal width that is perpendicular to the extending direction, and the longitudinal width of the first extension section is greater than the longitudinal width of the second extension section.

13. The electronic device according to claim 1, wherein the first parasitic radiation element includes a first branch, a second branch, and a matching element, the first branch is connected between the grounding element and the second branch, the matching element is disposed on the second branch, and the matching element is coupled with the first radiating portion.

14. The electronic device according to claim 1, wherein the first parasitic radiation element includes a first branch and a second branch that are connected with each other, and the first branch is connected between the grounding element and the second branch.

15. The electronic device according to claim 14, wherein the first parasitic radiation element further includes a third branch, a first matching element, a second matching element, and a third matching element, the third branch is connected to the first branch, the first matching element and the second matching element are disposed on the second branch, the third matching element is disposed on the third branch, the first matching element is coupled with the first grounding arm, the second matching element is coupled with the second grounding arm, and the third matching element is coupled with the feeding portion.

16. The electronic device according to claim 1, further including a proximity sensing circuit that is electrically connected to the first grounding arm or the second grounding arm, and the antenna structure further includes a first inductor and at least one capacitor; wherein the first inductor is electrically connected between the proximity sensing circuit and the first grounding arm, or between the proximity sensing circuit and the second grounding arm; wherein the at least one capacitor is electrically connected between the grounding element and the first grounding arm, and between the grounding element and the second grounding arm.

17. The electronic device according to claim 16, wherein the antenna structure further includes another capacitor, the feeding portion includes a first segment and a second segment, the first segment is connected to the first radiating portion, the second segment is electrically connected to the feeding element, and the another capacitor is electrically connected between the first segment and the second segment.

18. An antenna structure, comprising:
a grounding element; and
a feeding radiation element including a feeding portion, a first radiating portion, a second radiating portion, a first grounding arm, and a second grounding arm, wherein the feeding portion is connected between the first radiating portion and the second radiating portion, and the first grounding arm and the second grounding arm are connected to the first radiating portion;
a switching circuit electrically connected to the first grounding arm and the second grounding arm; and
a first parasitic radiation element connected to the grounding element and coupled with the feeding radiation element;
wherein the feeding portion is used to be fed a signal through the feeding element; in response to the switching circuit being switched to a first mode, the signal passes through the first grounding arm, and in response to the switching circuit being switched to a second mode, the signal passes through the second grounding arm.

19. The antenna structure according to claim 18, wherein a transmission path length of the signal from a feeding end of the feeding element to the grounding element via the first grounding arm is greater than a transmission path length of the signal from the feeding end to the grounding element via the second grounding arm.

20. The antenna structure according to claim 18, wherein the switching circuit includes a first path and a second path, the first path has a first switch, the second path has a second switch; wherein, in response to the switching circuit being switched to the first mode, the first switch is in a conducting state, and in response to the switching circuit being switched to the second mode, the second switch is in the conducting state; wherein an equivalent impedance of the first path is different from an equivalent impedance of the second path.
